(19) United States
(12) Patent Application Publication
(10) Pub. No.: US 2017/0124364 A1
(43) Pub. Date: May 4, 2017

(54) NON-ROTATIONALLY SYMMETRIC SHORT-RANGE WIRELESS TAG

(71) Applicant: Microsoft Technology Licensing, LLC, Redmond, WA (US)

(72) Inventors: Nicolas Villar, Cambridge (GB); Daniel Cletheroe, Stapleford (GB); Greg Saul, Cambridge (GB); Haiyan Zhang, Cambridge (GB); Christian Holz, Seattle, WA (US); Oscar Salandin, London (GB)

(21) Appl. No.: 15/231,760

(22) Filed: Aug. 8, 2016

Related U.S. Application Data
(63) Continuation-in-part of application No. 14/931,049, filed on Nov. 3, 2015.

(51) Int. Cl. G06K 7/10; H04B 17/318; G06K 19/077; H04B 5/00

(52) U.S. Cl. CPC G06K 7/10326; H04B 5/0031; H04B 17/318; G06K 7/10376; G06K 7/10138; G06K 19/07783; H04B 5/0081

(57) ABSTRACT

A short-range wireless tag has a conductive footprint which is not rotationally symmetric where this footprint is formed from an antenna within the short-range wireless tag and optionally one or more additional conductive areas within the short-range wireless tag. The orientation of such a short-range wireless tag may be determined by a sensing surface when the tag is placed on the surface and where the surface comprises an array of RF antennas and/or a capacitive sensing electrode array.

### CROSS-REFERENCE TO RELATED APPLICATION

This non-provisional utility application is a continuation-in-part of U.S. application Ser. No. 14/931,049 entitled “Multi-modal Sensing Surface” and filed on Nov. 3, 2015, which is incorporated herein in its entirety by reference.

### BACKGROUND

Near-field communication (NFC) and radio-frequency identification (RFID) readers can identify objects via parasitically powered tags which when activated transmit the identifier (ID) of the tag. The antenna within an NFC tag is round or rectangular and magnetic induction between the antenna in the tag and an antenna in a proximate NFC reader device provides the energy for the tag to communicate its ID back to the reader device. There are many uses for NFC tags including for authentication (e.g. where the NFC tag provides an access token), for automation (e.g. where the NFC tag may initiate an action, change settings, etc.), to bootstrap other wireless connections, in commerce (e.g. in a contactless payment system), in gaming, etc.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A short-range wireless tag has a conductive footprint which is not rotationally symmetric where this footprint is formed from an antenna within the short-range wireless tag and optionally one or more additional conductive areas within the short-range wireless tag. The orientation of such a short-range wireless tag may be determined by a sensing surface when the tag is placed on the surface and where the surface comprises an array of RF antennas and/or a capacitive sensing electrode array.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows schematic diagrams of various example improved short-range wireless tags;

FIG. 2 is a schematic diagram of a sensing surface;

FIG. 3 shows schematic diagrams of various different sensing arrays which may form part of the sensing surface of FIG. 3;

FIG. 4 is a flow diagram of an example method of operation of a sensing module within the sensing surface of FIG. 3;

FIG. 5 is a schematic diagram showing an example short-range wireless tag and a portion of an example sensing array;

FIG. 6A shows a flow diagram of another example method of operation of a sensing module within the sensing surface of FIG. 3;

FIG. 6B shows graphical representations of example capacitance measurements obtained using the method of FIG. 6A;

FIG. 7 is a flow diagram of a further example method of operation of a sensing module within the sensing surface of FIG. 3;

FIG. 8 shows schematic diagrams of various other example improved short-range wireless tags; and

FIG. 9 is a block diagram of an example sensing surface, such as the sensing surface of FIG. 3.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

As described above, NFC readers can identify objects via parasitically powered tags which when activated transmit the ID of the tag (which may be a unique ID). However, they do not provide information about the location of the object being identified. In contrast, capacitive sensing surfaces can detect the positions of one or more fingers on the sensing surface but cannot uniquely identify those objects.

The shape of the antenna within an NFC tag is square, circular or rectangular and all these shapes have at least some rotational symmetry when detected by either an array of RF antennas or a capacitive sensing electrode array. The shape of the antenna is designed to be rotational symmetric to maximize the field distribution and increase the consistency with which an NFC tag can be read.

The embodiments described below are not limited to implementations which solve any or all of the disadvantages of known sensing surfaces or NFC tags.

Described herein are various improved short-range wireless tags (e.g. NFC or near-field RFID tags) which comprise a conductive footprint (which may also be referred to as a conductive imprint) (e.g. in terms of the antenna shape and/or additional conductive elements) which is different depending on the orientation of the short-range wireless tag (i.e. the footprint is not rotationally symmetric and may also be described as non-rotationally symmetric or rotationally asymmetric or without being rotationally symmetric). This enables the orientation of the short-range wireless tag (and hence the orientation of an object comprising the tag) to be determined by a sensing surface comprising a sensing array, where the sensing array is an array of RF antennas or a capacitive sensing electrode array. The term ‘conductive footprint’ is used herein to refer to the shape of the conductive material within the tag that is detectable by a sensing array (e.g. a capacitive sensing electrode array or an array of RF antennas).

Various examples of short-range wireless tags which have a conductive footprint which is different depending on the orientation of the short-range wireless tag (i.e. a conductive footprint which is not rotationally symmetric) are described below. In various examples the short-range wireless tags comprise an antenna which lacks rotational symmetry (i.e. the antenna is not rotationally symmetric and may also be described as non-rotationally symmetric or rotationally asymmetric or without being rotationally symmetric), such as short-range wireless tags comprising an antenna with two or more different ends (e.g. in terms of size, shape and/or dielectric permittivity) and short-range wireless tags with a coil shape that lacks rotational symmetry. The orientation of such tags may be determining using a sensing surface comprising an array of RF antennas as the shape of the antenna means that it couples with reader RF antennas in a non-uniform way as it is rotated. The orientation of such tags may alternatively be determined based on capacitive measurements made by a sensing surface comprising a capacitive sensing electrode array.

In other examples the short-range wireless tags comprise additional conductive features which are separate from the antenna (but may be proximate to the antenna) and where the conductive features (when considered alone and/or in combination with the antenna) provide a conductive footprint which lacks rotational symmetry (i.e. the conductive features are not rotationally symmetric and may also be described as non-rotationally symmetric or rotationally asymmetric or without being rotationally symmetric). The orientation of such tags may be determined using a sensing surface comprising a capacitive sensing electrode array.

Further examples include 3D short-range wireless tag. A first example 3D short-range wireless tag comprises an antenna having a first part adjacent to a first face of the tag and a second part adjacent to a second face of the tag and where the shape of the first and second parts are different (where the first and second faces may be adjacent or opposite). A second example 3D short-range wireless tag comprises an embedded antenna (which may be rotationally symmetric) and different conductive features on different faces. The orientation of such 3D short-range wireless tags may be determined using a sensing surface comprising a capacitive sensing electrode array.

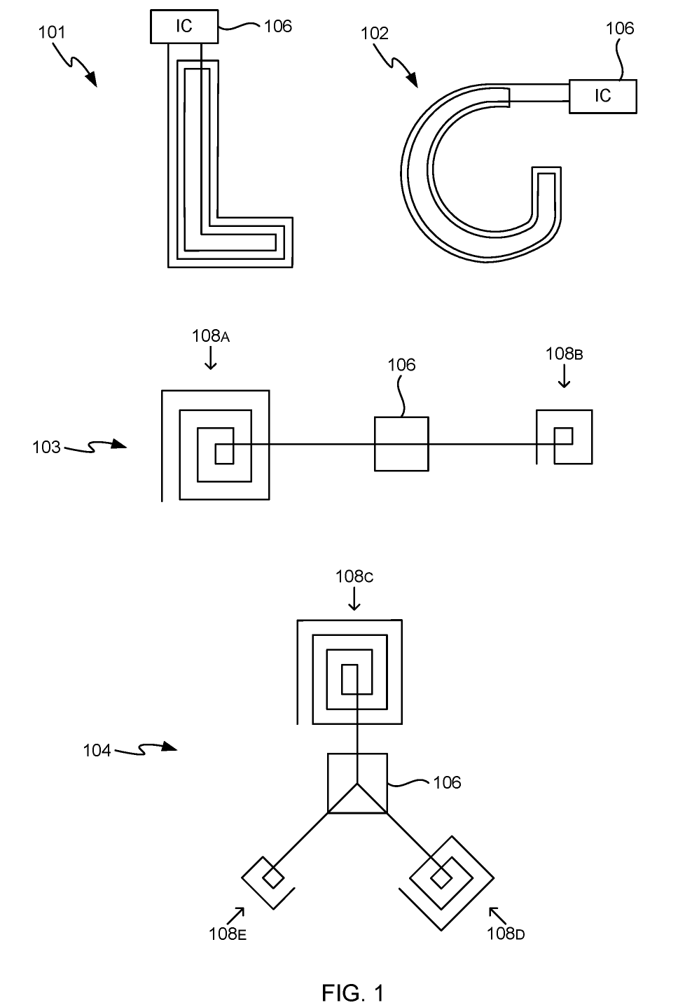

FIG. 1 shows schematic diagrams of various example improved short-range wireless (e.g. NFC) tags 101-104 which all comprise antennas that lack rotational symmetry. In the first example 101, the antenna is an L-shaped coil connected to an IC 106 (e.g. an NFC IC) and in the second example 102, the antenna is a G-shaped coil connected to an IC 106. Both of these antennas have a shape which lacks both rotational and mirror symmetry, although in other examples, the antennas may lack rotational symmetry but have mirror symmetry (e.g. a V-shaped antenna). Antennas in other shapes without rotational symmetry may also be used as long as the antenna can still electromagnetically couple with a reader antenna. This may provide constraints in relation to the number of turns in the antenna coil, the dimensions of the antenna coil and the field shape of the antenna.

The third and fourth examples 103, 104 in FIG. 1 comprise an antenna connected to an IC 106 where the antenna has multiple, spatially separated, ends 108A-E which are different sizes and the IC is connected to the middle of the antenna (i.e. at a point between the ends). Alternatively, the ends may differ in a different way (e.g. with different ends / parts made from materials with different dielectric permittivity and hence different capacitive coupling between electrodes). Both of the antennas shown in the third and fourth examples 103, 104 lack rotational symmetry and the antenna in the fourth example 104 additionally lacks mirror symmetry.

In various examples, the antennas comprise two or more portions (or legs) that are not in line and do not have the same length (e.g. as in examples 101 and 104 in FIG. 1) and/or are curved and have different radii of curvature (e.g. as in example 102 in FIG. 1). It will be appreciated that the antennas shown in FIG. 1 are examples and other shapes and configurations may alternatively be used.

Although the antennas shown in the third and fourth examples 103, 104 are planar, in other examples, the antennas may not be planar such that the tag is a 3D tag. In such examples, one end (e.g. end 108A) of the antenna may be proximate to a first face of the tag and another end (e.g. end 108B) may be proximate to another face of the tag, where the two faces may, for example, be opposite or adjacent.

As a consequence of the lack of rotational symmetry of the antennas shown in FIG. 1, the rotational orientation of the tag when placed on a sensing surface can be determined. In addition, where the antenna also lacks mirror symmetry, it may also be possible to detect whether the tag has been flipped (i.e. turned) over or not, e.g. if the tag is mounted in / on a card (or other thin object) with two sides, side A and side B, it is possible to determine whether the card has been placed on the sensing surface with side A visible (and side B facing the sensing surface) or with side B visible (and side A facing the sensing surface).

The orientation of the short-range wireless tags shown in FIG. 1 may be detected by a sensing surface comprising a sensing array where this sensing array may be an array of RF antennas (for examples 103, 104) or a capacitive sensing electrode array (for any of examples 101-104) and in some examples the sensing surface may comprise both an array of RF antennas and a capacitive sensing electrode array. The detected orientation (e.g. the rotational orientation and in some examples information about which face of the tag is on the sensing surface) which is determined by the sensing surface may be provided as an input to software running on a processor which may be integral to the sensing surface or which may be in a computing device which is connected to the sensing surface (e.g. via a wired or wireless link).

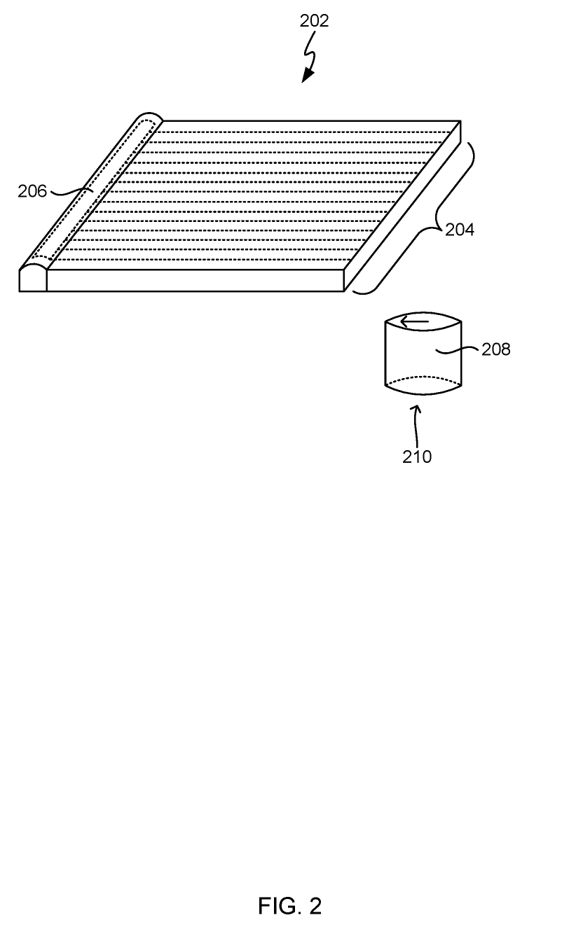

FIG. 2 is a schematic diagram of a sensing surface 202 comprising a sensing array 204 connected to a sensing module 206 (which may comprise a microprocessor control unit, MCU). FIG. 2 also shows an object 208 which comprises a short-range wireless tag with an antenna that lacks rotational symmetry, such as any of the tags shown in FIG. 1. For example, the short-range wireless tag with the asymmetric antenna may be attached to a bottom face 210 of the object 208. The orientation of the object 208 (e.g. its rotational position) can be detected by the sensing surface 202 and may be used to provide an input to a computing device (which may be connected to or integrated with the sensing surface 202), e.g. such that to a user, the position of the arrow on the top face of the object 208 acts as an input to the software (e.g. as a volume controller, a zoom controller, etc.).

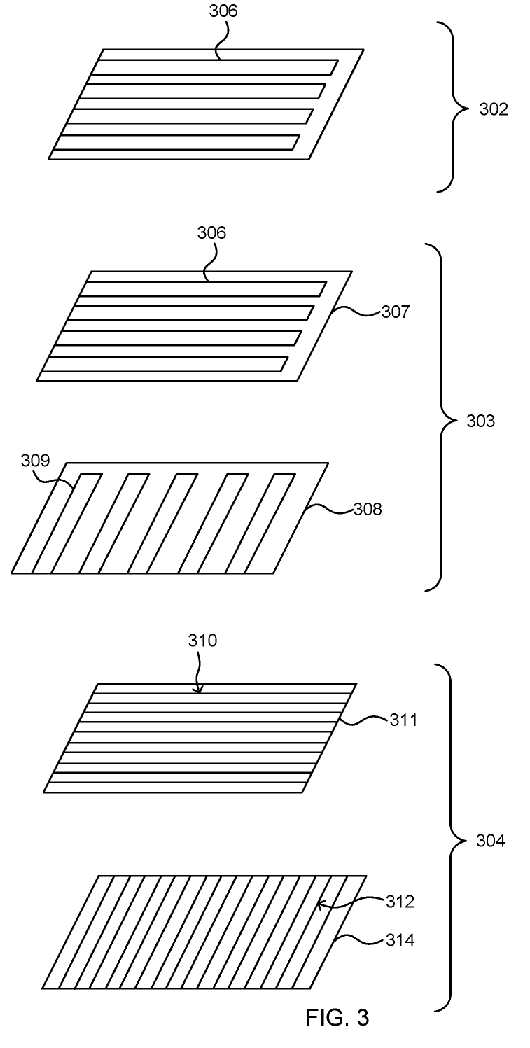

Examples of the sensing array 204 are shown in more detail in FIG. 3 and may comprise an array of RF antennas 302 and/or a capacitive sensing electrode array 304. A sensing surface 202 comprising both an array of RF antennas 302, 303 and a capacitive sensing electrode array may be referred to as a multi-modal sensing surface and a sensing surface 202 comprising only RF antennas (and no capacitive sensing electrode array) or only a capacitive sensing electrode array (and no RF antennas) may be referred to as single-mode sensing surface.

In examples where the sensing array 204 comprises an array of RF antennas 302, the array 302 may comprise a plurality of loop antennas 306 in a single plane. Alternatively, the sensing array 204 may comprise two arrays of RF antennas 303 in separate, parallel planes 307, 308, with each array comprising a plurality of loop antennas 306, 309. Two sets of RF antennas, as shown in FIG. 3 may be provided to enable the sensing surface 202 to distinguish between two tags at different locations but which are both proximate to the same RF antenna (such that if there was only one set of antennas, a single RF antenna would be able to read the tags in both objects) and/or to detect the orientation of a short-range wireless tag which has an antenna which is substantially aligned with the antennas in one of the arrays. In the example 303 shown in FIG. 3 the two sets of antennas 306, 309 are arranged perpendicular to each other in a row/column matrix such that one set may be referred to as the x-axis antennas and the other set may be referred to as the y-axis antennas. In other examples, however, the sets of antennas may be arranged such that they are not exactly perpendicular to each other but instead the antennas cross at a different angle. The two sets of antennas 306, 309 are separated by some insulation which may be in the form of an insulating layer (not shown in FIG. 3) or insulation over the wires that form one or both of the sets of antennas 306, 309.

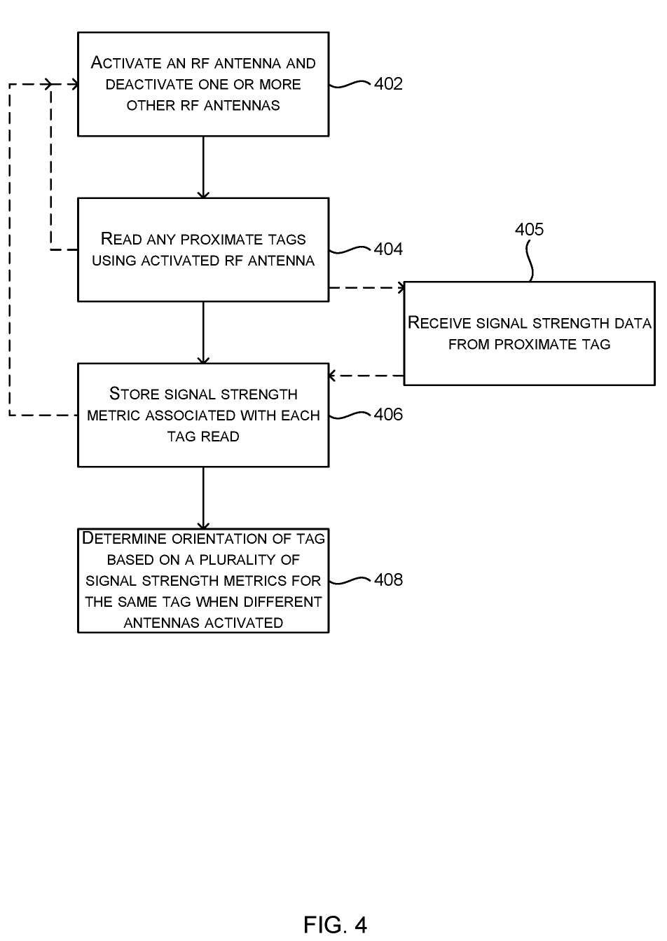

In examples where the sensing surface 204 comprises an array of RF antennas 302, 303, the sensing module 206 is coupled to the array of RF antennas and is configured to selectively tune and detune the RF antennas in the array, where, when tuned, these antennas are tuned to the same frequency as the wireless tags in the objects (e.g. 13.56MHz for NFC) such that the sensing module can activate a proximate wireless tag and receive data from the tag (e.g. a unique ID of the tag). An example method of operation of such a sensing module is described below with reference to FIG. 4.

In examples where the sensing array 204 comprises a capacitive sensing electrode array 304, the array 304 comprises a first set of electrodes 310 in a first layer 311 and a second set of electrodes 312 in a second layer 314. In the example shown in FIG. 3 the two sets of electrodes 310, 312 are arranged perpendicular to each other such that one set may be referred to as the x-axis electrodes and the other set may be referred to as the y-axis electrodes. In other examples, however, the sets of electrodes may be arranged such that they are not exactly perpendicular to each other but instead the electrodes cross at a different angle. The sets of electrodes 310, 312 are separated by some insulation which may be in the form of an insulating layer (not shown in FIG. 3) or insulation over the wires that form one or both of the sets of electrodes 310, 312.

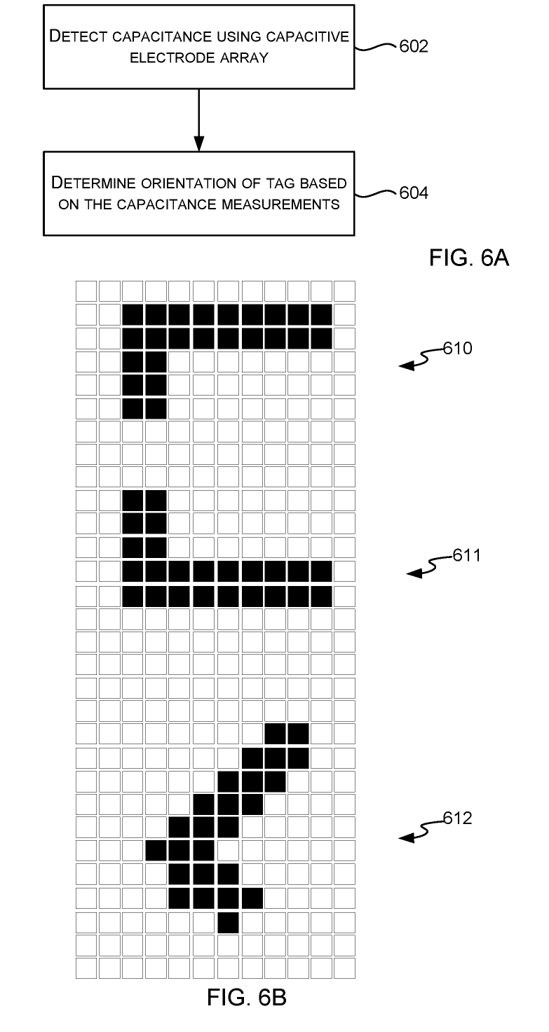

In examples where the sensing surface 204 comprises a capacitive sensing electrode array 304, the sensing module 206 is coupled to the capacitive sensing electrode array 304 and is configured to detect both a decrease and an increase in the capacitance between electrodes in the array. An example method of operation of such a sensing module is described below with reference to FIG. 6A.

In various examples, the sensing surface 202 may comprise both an array of RF antennas 302, 303 and/or a capacitive sensing electrode array 304. In such examples, the sensing surface 202 comprises a first sensing module and a second sensing module. The first sensing module is coupled to the capacitive sensing electrode array and is configured to detect both a decrease and an increase in the capacitance between electrodes in the array. The second sensing module is coupled to the array of RF antennas and is configured to selectively tune and detune the RF antennas in the array, where, when tuned, these antennas are tuned to the same frequency as the wireless tags in the objects (e.g. 13.56 MHz for NFC) such that the second sensing module can activate a proximate wireless tag and receive data from the tag (e.g. a unique ID of the tag). Example methods of operation of such a sensing surface is described below with reference to FIGS. 4, 6 and 7.

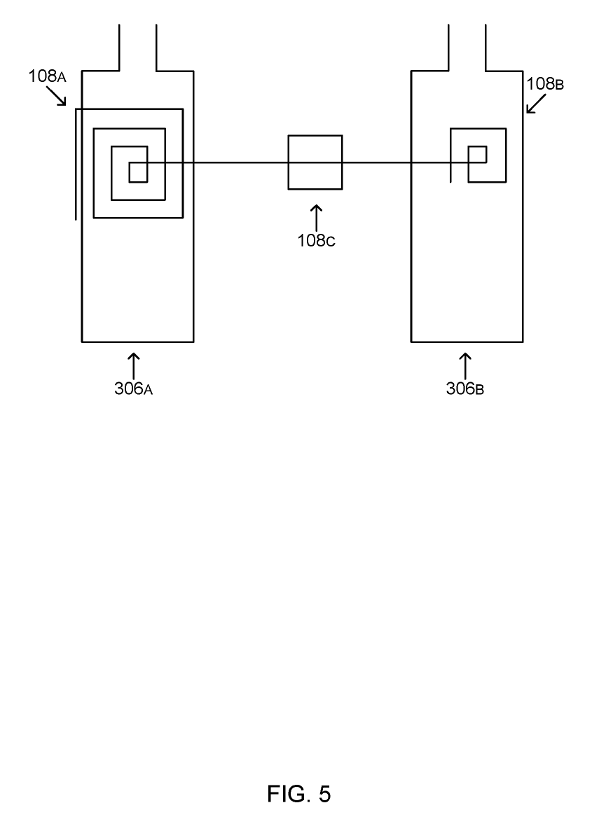

A first example method of detecting the orientation of a short-range wireless tag using a sensing array 204 comprising an array of RF antennas 302, 303 (irrespective of whether the sensing surface 202 is single-mode or multi-modal) can be described with reference to the flow diagram in FIG. 4 and the example shown in FIG. 5 which shows an enlarged portion of an array of RF antennas (such that only two loop antennas 306A, 306B are visible) and the third example tag 103 from FIG. 1. As detailed above this method may be used where the short-range wireless tag comprises an antenna which has a plurality of ends with different coupling properties (e.g. the latter two example tags 103, 104 shown in FIG. 1).

The method of FIG. 4 involves scanning through some or all of the RF antennas in the array 302, 303 (which may be referred to as reader antennas) and recording a signal strength metric for any proximate tags. An RF antenna is activated and one or more other RF antennas (including antennas immediately adjacent to the activated antenna) are deactivated (block 402). The deactivation of an RF antenna (which may also be referred to as ‘detuning’) may be implemented in many different ways, for example by shorting the two halves of the loop via a transistor or making the tuning capacitors (which would otherwise tune the antenna at the right frequency) open-circuit (using a transistor). This selective activating and deactivating (which may also be described as selective tuning and detuning) of the RF antennas stops the antennas from coupling with each other (e.g. such that the power is not coupled into another antenna, which may then activate tags proximate to that other antenna and not the original, powered antenna).

The activated RF antenna (i.e. the antenna which has not been deactivated in block 402) is then used to read any proximate short-range wireless tags (block 404, by the sensing module 206). When reading the proximate short-range wireless tags (in block 404), a signal strength metric associated with each of the tags which are read by the particular activated antenna, may be measured and stored by the sensing module (block 406). In addition, or instead, the short-range wireless tag may measure and record a signal strength metric when it is activated by an RF antenna and this may be immediately or subsequently communicated to the sensing surface (e.g. individually or in a batch of values) and then stored by the sensing module (in block 406).

The signal strength metric may, for example, be the received signal strength (RSSI), signal to noise ratio (SNR), where the measurement is made by the sensing surface (e.g. by the sensing module in the sensing surface) or it may be a modulation depth (e.g. in Volts) as detected at the tag and which is proportional to the coupling between the activated RF reader antenna (in the sensing surface) and the antenna in the tag. In other examples, the forward transmit power may be sensed (e.g. the power delivered out of the power amplifier of the reader device) or the mismatch between antennas (e.g. the ratio between reflected and forward power).

By making the measurement at the wireless tag (in addition to, or instead of, making the measurement at the sensing module, the measurement may be more accurate. This is because the sensing module may estimate the coupling or signal quality indirectly, e.g. based on metrics such as how much power is reflected or signal to noise ratio (SNR). If there are multiple tags or other non-tagged objects that may couple on the antenna, it may make the estimate inaccurate (e.g. as it is hard to know how much power is being transmitted to any one tag). The tag, however, can make a direct measurement (e.g. by sensing how much power it is actually receiving). In various examples, measurements are made by both the reader and tag as this provides data on both how much data is emitted by the reader and how much is reflected and how much is actually being received by the tag.

Where the short-range wireless tag records signal strength metrics, the stored values may be time-stamped and/or stored in a sequence in which they were measured such that the sensing module 206 can correlate the received signal strength data (as received in block 405) with the particular antenna which was activated when the measurement was made. Alternatively any other suitable technique for correlating the stored metrics and the particular RF antenna may be used.

The method is then repeated (as indicated by the dotted arrows back from block 404 or block 406 to block 402) with the activation of a different RF antenna and the deactivation of at least the immediately adjacent RF antennas and in some examples, the deactivation of all other RF antennas in the array. By repeating the method to scan through a plurality of the RF antennas in the array, signal strength metrics are obtained and stored (in block 406) for each of the plurality of RF antennas. The orientation of a short-range wireless tag can then be determined based on a plurality of signal strength metrics which relate to the same tag but different RF antennas, i.e. they were measured in relation to the same tag when different RF antennas were activated (block 408).

Any suitable method of determination may be used (in block 408) and this may involve pattern matching (e.g. comparing the signal strength metrics to template data sets, each template data set corresponding to a predefined tag shape at one of a number of different predefined orientations, to identify a closest match), machine learning, etc. In various examples, the ID of the tag provides the sensing module with information on characteristics of the tag/antenna (e.g. the antenna shape which may be obtained by means of a look-up function using the tag ID) and these characteristics may then be used when determining orientation (e.g. using the tag ID, the sensing module can determine if a tag looks like the third example 103 in FIG. 1 or the fourth example 104) and this may simplify and/or speed up the determination operation (e.g. by reducing the number of template data sets which are included in a comparison with the measured results).

The determination (in block 408) may comprise, looking for patterns within a small neighborhood (e.g. where the size of a tag is predefined). To detect lines, algorithms, such as Hough lines, may be used. Similarly, to detect circles, Hough circles may be used. Both provide a likelihood of present lines/circles and orientations. Given knowledge of the tag shape, it can be verified if the tag is among the detected probabilities for line/circle orientations. For example, the determination may find a center coordinate in the pattern and walk around at a constant radius to detect intersections with patterns of the tag. If this is repeated at two radii, one of which crosses both the short and the long part of the L (e.g. for an antenna shape such as in examples 101 or 104 in FIG. 1), while the other only crosses the longer leg, the orientation can also be detected. Alternatively, simple image convolution may be performed using a kernel that reflects the tag shape. This is simple for a circular pattern and slightly more challenging for an L shape. To more generally detect markers independent of their rotation, a log polar transform of the image may be created and then the method may look for the translated imprint (whose pattern is known). To accommodate shapes of various sizes, a Fourier Mellin transform may be applied to the sensed image (e.g. the capacitive sensed image) to detect known patterns independent of their translation, rotation, and scale.

Referring to the example in FIG. 5, if when activating the left RF antenna 306A, a signal strength metric of 100 is obtained (e.g. either by the sensing module directly or by the tag with the data then being communicated to the sensing module) and when activating the right antenna 306B and a signal strength metric of 50 is obtained, then it can be determined (in block 408) that the orientation of the tag 103 is as shown in FIG. 5. The left-hand end 108A of the antenna is larger and hence will couple more strongly with the reader antennas, while the right-hand end 108B of the antenna in the tag 103 is smaller and couple less weakly. The tag couples to both RF antennas (when they are activated), but the two signal strength metrics will reflect the differences in coupling. If however, a signal strength metric of 50 is obtained (e.g. either by the sensing module directly or by the tag with the data then being communicated to the sensing module) when activating the left RF antenna 306A and when activating the right RF antenna 306B a signal strength metric of 100 is obtained, then it can be determined that the orientation of the tag 103 is rotated by 180° from the position shown in FIG. 5. Intermediate readings may represent an angle of rotation from the position shown in FIG. 5 which is less than 180°. In various examples intermediate readings may also be caused by misalignment of an antenna with a reader antenna; however, by averaging the readings of multiple adjacent antennas, the method may disambiguate between intermediate readings caused by misalignment and those caused by the orientation of the tag.

When scanning through RF antennas in repeated iterations of the method shown in FIG. 4, the method may activate all of the RF antennas in the array in turn, where in any iteration there may be one or more than one RF antenna activated and where more than one RF antenna is activated, the activated RF antennas are spatially separated. Where more than one RF antenna is tuned and powered at the same time, these antennas are selected to be sufficiently far apart that there is no effect on one powered RF antenna from any of the other powered RF antennas. In other examples, however, the method may not be repeated for all of the RF antennas in the array but instead for only a proper subset of the RF antennas and in various examples, the subset may be defined dynamically based on the identity and/or number of tags read by any activated RF antenna. In various examples, the method may be repeated to implement a search strategy. In an example, only antennas 1, 3, 5, 7 . . . may be activated in turn and then one or more of the even number antennas may be activated if a tag is read by an adjacent odd numbered antenna. Such search strategies which do not involve cycling through all of the RF antennas may be particularly useful as the density of reader antennas increases and hence the time taken to scan through all antennas increases.

A second example method of detecting the orientation of a short-range wireless tag using a sensing array 204 comprising a capacitive sensing electrode array 304 (irrespective of whether the sensing surface 202 is single-mode or multi-modal) can be described with reference to the flow diagram in FIG. 6A and to the graphical representations of example capacitance measurements shown in FIG. 6B. The measurements shown in FIG. 6B correspond to the first example tag 101 from FIG. 1 in three different orientations 610-612.

As described above, the sensing surface 202 comprises a sensing module 206 which is coupled to the capacitive sensing electrode array 304 and is configured to detect an increase in the capacitance between electrodes in the array or to detect both a decrease and an increase in the capacitance between electrodes in the array. A decrease of mutual capacitance between electrodes (i.e. between one or more electrodes in the first set of electrodes 310 and one or more electrodes in the second set of electrodes 312) may be used to detect a user's fingers in the same way as conventional multi-touch sensing. Unlike conventional multi-touch sensing, however, the sensing module 206 can also detect an increase in the capacitance between electrodes in the array. An increase in mutual capacitance between electrodes (i.e. between one or more electrodes in the first set of electrodes 310 and one or more electrodes in the second set of electrodes 312) is used to detect the orientation of a short-range wireless tag which may be incorporated in a non-conductive housing. Unlike a user's finger, such a tag has no connection to ground and instead it capacitive couples adjacent electrodes (consequently, the tag does not need to have a high electrical conductivity and instead can be made from, or include, any conductive material).

The method of FIG. 6A comprises detecting capacitance across the capacitive sensing electrode array 304 (block 602) and determining the orientation of the tag based on the capacitance measurements in FIG. 6B (block 604). The detection (in block 602) may, for example, comprise detecting an area of increased capacitance using the capacitive sensing electrode array 304. As shown clearly in the graphical representations of the capacitance measurements (where the filled squares indicate an increased capacitance measurement compared to the unfilled squares), the L-shape of the antenna in the tag can be clearly seen and the different orientations identified. Any suitable method of determination may be used (in block 604) and this may involve and of the methods described above with reference to block 408, pattern matching, machine learning, etc.

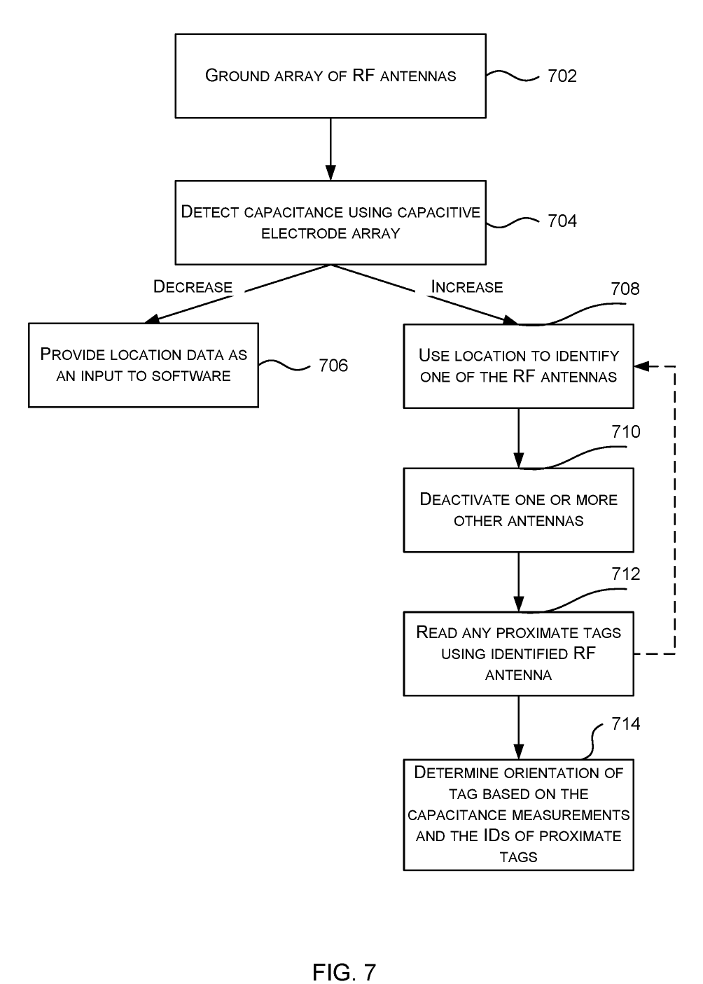

A third example method of detecting the orientation of a short-range wireless tag using a multi-modal sensing surface (as described above) can be described with reference to the flow diagram in FIG. 7. As described above, such a multi-modal sensing surface comprises a first sensing module connected to the capacitive sensing electrode array and a second sensing module connected to the array(s) of RF antennas.

Whilst all the RF antennas (in array(s) 302, 303) are grounded (block 702, by the second sensing module), the sensing surface 202 can detect changes in capacitance using the capacitive electrode array 304 (block 704, by the first sensing module). If the first sensing module detects a decrease in capacitance at a location on the sensing surface (in block 704), this does not indicate the presence of a short-range wireless tag but instead this may be the location of a user's finger and so, in various examples, this location may be provided as an input to software (block 706, e.g. where the software may be running on a processor in the sensing surface 202 or in a separate computing device).

If the first sensing module detects an increase in capacitance at a location on the sensing surface (in block 704), the location is used to identify one of the RF antennas (block 708, by the second sensing module) and then all other RF antennas are deactivated (block 710, by the second sensing module). The identified RF antenna (which has not been deactivated in block 710) is then used to read any proximate wireless tags (block 712, by the second sensing module). The reading of a proximate wireless tag (in block 712) comprises activating the tag and then reading data transmitted by the activated tag.

In some examples, the location which is identified (in block 704, by the first sensing module) may be between two RF antennas in the same set (e.g. set 306 or set 309 in example 303 in FIG. 3) and/or correspond to one RF antenna in each set of antennas 306, 309. In such examples, blocks 708-712 may be repeated for each RF antenna that corresponds to the location.

Having located and identified an object with a wireless tag on the sensing surface using the method described above, the orientation of the detected tags is determined based on the capacitance measurements and optionally based also on the IDs received (e.g. which may be used to look-up the shape of the tag which can then be compared, in block 712, to the capacitance measurements; however, the ID is not required to determine the orientation). Use of both the ID data and the capacitance measurements may allow the orientation to be determined more quickly and/or may enable the sensing surface to distinguish between multiple tags which are in very close proximity to each other (e.g. where they appear, at the resolution of the capacitive measurements, to be touching) Additionally, it enables the sensing surface to distinguish between short-range wireless tags which are on placed on the surface and other objects which comprise conductive elements but which do not comprise a tag.

By using a combination of RF and capacitive sensing, as described above, the tag simultaneously acts as a functional short-range wireless (e.g. NFC) antenna and as a capacitive marker. The wireless sensing enables the IO aspect, whereas the capacitive sensing enables more precise positioning, rotation, and touch detection on and around the tag.

In various examples, the identification of an RF antenna (in block 708) may not occur in response to all detections of an increase in capacitance (in block 704). Instead, if the possible shape(s) of the short-range wireless tag(s) is known, the activation and reading of proximate tags may only be triggered in response to detecting a matching pattern (in any orientation) within the capacitive data (in block 704).

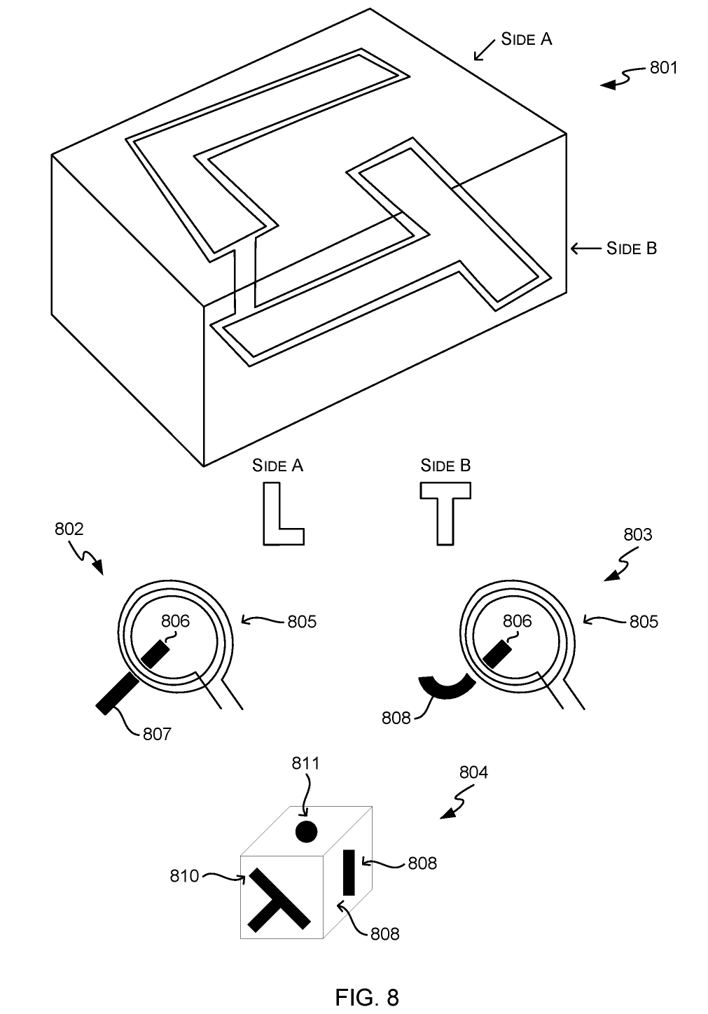

FIG. 8 shows schematic diagrams of various other example improved short-range wireless (e.g. NFC) tags. Unlike the tags 101-104 shown in FIG. 1, the tags 801-804 shown in FIG. 8 do not necessarily comprise antennas that lack rotational symmetry. The first example tag 801 shown in FIG. 8 is a three-dimensional (3D) tag with an antenna which is not within a single plane (unlike the antennas shown in FIG. 1) and extends across two faces, with a portion on a first face (side A) and a portion on a second face (side B) where these two portions have a different shape. The shapes of the portions of the antenna on each face may have rotational symmetry or may lack rotational symmetry (as in the example shown in FIG. 8). The orientation of this tag 801 (e.g. which face is in contact with the sensing surface) may be determined using capacitive measurements according to the method of FIG. 6A or 7 as described above.

The latter three example tags 802-804 shown in FIG. 8 each comprise an antenna 805 which is rotationally symmetric and the tags further comprise one or more additional conductive regions 806-811 which result in an overall conductive footprint which is different for different orientations of the tag (and in many cases which lacks rotational symmetry). The extra regions 806-811 may be inside the antenna (e.g. region 806) and/or outside the antenna coil 807-811. The fourth example tag 804 in FIG. 8 shows a 3D object comprising a short-range wireless tag and different shaped conductive regions 809/811 (which may also be referred to as capacitive fiducials) on different faces (e.g. on each face of the object). The orientation of any of these tags 802-804 may be determined using capacitive measurements according to the method of FIG. 6A or 7 as described above.

The third example tag 803 shown in FIG. 8 lacks both rotational and mirror symmetry and as a consequence of the lack of mirror symmetry it may be possible to detect whether the tag has been flipped over or not using the capacitive measurements. For example if the tag is mounted in/on a card with two sides, side A and side B, it is possible to determine whether the card has been placed on the sensing surface with side A visible (and side B facing the sensing surface) or with side B visible (and side A facing the sensing surface).

The use of non-rotationally symmetric conductive elements which are separate from the antenna coil, as in the latter two tags 802-803 in FIG. 8, results in a larger tag because the additional conductive regions 805-808 need to be relatively large (in order that they can be resolved by the capacitive sensing electrode array 304) and they cannot overlap the antenna coil; however the additional conductive regions may improve the stability of detection and may enable modification of off-the-shelf tags by augmenting them with additional conductive elements. In contrast, the example tags shown in FIG. 1 involve a reshaping of the antenna and in various examples this need not increase the size of the tag or the amount of metal the tag contains.

Using the methods described above (with reference to FIGS. 4, 6 and 7), the orientation of a short-range wireless tag can be determined (in blocks 408, 604 and 714) and this may be provided as an input to software, e.g. where the software may be running on a processor in the sensing surface 202 or in a separate computing device. In various examples the sensing surface may also determine the position of the tag on the sensing surface (in addition to the orientation). The orientation information adds an extra degree of input to the software. This may be used in very many different ways. For example, it may be used to provide a volume or other variable input by rotating an object (e.g. object 208 shown in FIG. 2) comprising a short-range wireless tag as described herein on a sensing surface. In another example, it may be used to detect the orientation of objects (e g gaming characters) each comprising a short-range wireless tag as described herein on a sensing surface. In a further example, it may be used to detect whether a card or token comprising a short-range wireless tag as described herein has been placed face up or face down on a sensing surface. All these examples provide a user with a natural and intuitive way to provide a user input to software by interacting with a physical object. This may be particularly beneficial for users who find it difficult to use other user input techniques (e.g. young children, users with limited dexterity, users with reduced vision and for whom tactile input may be easier, etc.) or for applications which are not suited to other user input techniques.

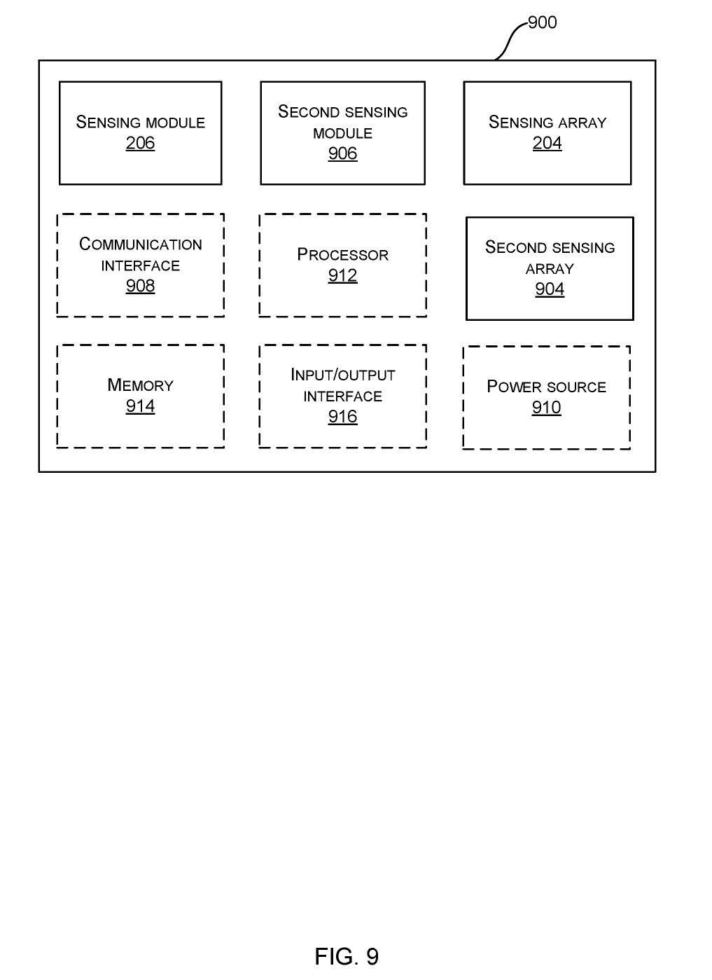

FIG. 9 shows a block diagram of an example sensing surface 900 (which may be the sensing surface 202 shown in FIG. 2). As described above, the sensing surface 900 comprises a sensing array 204and a sensing module 206 and may additionally comprise a second sensing array 904 and a sensing module 906. If a sensing module 206, 906 is coupled to a sensing array 204, 904 comprising a capacitive sensing electrode array, the sensing module 206, 906 is configured to detect both a decrease and an increase in the capacitance between electrodes in the array. If a sensing module 206, 906 is coupled to a sensing array 204, 904 comprising one or more arrays of RF antennas, the sensing module 206, 906 is configured to selectively tune and detune the RF antennas in the array. Where the sensing surface 900 comprises both a first sensing array 204 which is a capacitive sensing electrode array and a second sensing array 904 which comprises one or more arrays of RF antennas, the second sensing module 906 may be further configured to connect all the RF antennas to ground when the first sensing module 206 is operating. This prevents the capacitive sensors from sensing activity on the non-touch-side of the sensing mat.

Depending upon the implementation of the sensing surface 900, it also comprise a communication interface 908 arranged to communicate with a separate computing device (e.g. which runs the software which receives the orientation data as a user input) using a wired or wireless technology. The sensing surface 900 may further comprise a power source 910. In examples where the power source 910 comprises an input connection for an external power source (e.g. a USB socket) and the communication interface 908 uses a wired protocol (e.g. USB), the communication interface 908 and power source 910 may be integrated.

In various examples, the sensing surface 900 may be integrated with a computing device such that it further comprises a processor 912, memory 914, display interface 916, etc. In other examples, the sensing surface 900 may be integrated within a peripheral for a computing device e.g. within a keyboard.

The functionality of one or both of the sensing modules 206, 906 described herein may be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs). In other examples, one or both of the sensing modules 206, 906 may comprise a processor, where the processor may be a microprocessor, controller or any other suitable type of processor for processing computer executable instructions to control the operation of the sensing module in order to implement the methods described herein.

In examples where the sensing surface 900 is integrated with a computing device, the processor 912 may be a microprocessor, controller or any other suitable type of processor for processing computer executable instructions to control the operation of the device in order to implement functionality of the computing device (e.g. to run an operating system and application software). The operating system and application software may be provided using any computer-readable media that is accessible by the sensing surface 900. Computer-readable media may include, for example, computer storage media such as memory 914 and communications media. Computer storage media, such as memory 914, includes volatile and non-volatile, removable and non-removable media implemented in any method or technology for storage of information such as computer readable instructions, data structures, program modules or the like. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage media (memory 914) is shown within the sensing surface 900 it will be appreciated that the storage may be distributed or located remotely and accessed via a network or other communication link (e.g. using communication interface 908).

The sensing surface 900 may also comprise an input/output interface 916 arranged to output display information to a display device which may be separate from or integral to the sensing surface 900. The display information may provide a graphical user interface. The input/output interface 916 may also be arranged to receive and process input from one or more devices, such as a user input device (e.g. a mouse, keyboard, camera, microphone or other sensor). In some examples the user input device may detect voice input, user gestures or other user actions and may provide a natural user interface (NUI). The input/output interface 916 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although various examples of shapes of antennas and conductive footprints are described above and illustrated in the accompanying drawings, the short-range wireless tags described herein may have alternative shaped conductive footprints which are different depending on the orientation of the tag (e.g. as a consequence of the antenna shape and/or extra conductive features). Similarly, other arrangements of RF antennas and/or sensing electrodes may be provided within a sensing surface (e.g. a 2D grid of RF antennas). Additionally, although the description above refers to use of passive tags, the short-range wireless tags described herein may alternatively be active tags (e.g. powered by an internal battery or power harvesting).

A first further example provides a short-range wireless tag having a conductive footprint that is not rotationally symmetric.

The short-range wireless tag may comprise an antenna that is not rotationally symmetric.

Alternatively or in addition to any of the preceding examples, the antenna may comprise a first end and a second end wherein the first and second end have different coupling properties and the tag further comprises an IC connected to the antenna between the first and second ends.

Alternatively or in addition to any of the preceding examples, the antenna may comprise a third end and wherein the IC is connected to the antenna between the first, second and third ends.

Alternatively or in addition to any of the preceding examples, the antenna may comprise a first portion having a first length and a second portion having a second length, wherein the first and second portions are not arranged in line with each other and the first and second lengths are different.

Alternatively or in addition to any of the preceding examples, the antenna may comprise a first portion having a first radius of curvature and a second portion having a second radius of curvature, wherein the first and second radii of curvature are different.

Alternatively or in addition to any of the preceding examples, the antenna may comprise a coil which is not rotationally symmetric. The coil may additionally lack mirror symmetry.

Alternatively or in addition to any of the preceding examples, the short-range wireless tag may comprise an antenna that is rotationally symmetric and one or more conductive regions that alone or in combination with the antenna provide the conductive footprint that is not rotationally symmetric. The conductive footprint may additionally lack mirror symmetry and the one or more conductive regions alone or in combination with the antenna provide the conductive footprint.

A second further example provides a method of detecting orientation of a short-range wireless tag using a sensing surface, the short-range wireless tag comprising an antenna which is not rotationally symmetric, the sensing surface comprising an array of RF antennas connected to a sensing module and the method comprising: activating, in the sensing module, an RF antenna from the array of RF antennas and deactivating, in the sensing module, one or more other RF antennas from the array of RF antennas; reading, at the sensing module, any proximate short-range wireless tags using the activated RF antenna; storing, at the sensing module, a signal strength metric associated with each short-range wireless tag read by the activated RF antenna; repeating the activating and deactivating, reading and storing for a different activated RF antenna; and determining an orientation of one of the short-range wireless tags based at least in part on a plurality of signal strength metrics for the same short-range wireless tag when activated by different RF antennas from the array of RF antennas.

The signal strength metrics may be generated in the sensing module based on measurements of signal strength made in the sensing surface.

Alternatively or in addition to any of the preceding examples, the signal strength metrics may be generated in the proximate short-range wireless tags based on measurements of voltages generated within the short-range wireless tags in response to activation of an RF antenna in the sensing surface.

Alternatively or in addition to any of the preceding examples, the method may further comprise receiving, at the sensing surface from a proximate short-range wireless tag, signal strength metrics generated in the short-range wireless tag when activated by different RF antennas from the array of RF antennas.

Alternatively or in addition to any of the preceding examples, the orientation of one of the short-range wireless tags may be determined based on an identifier read from the short-range wireless tag and the plurality of signal strength metrics for the same short-range wireless tag when activated by different RF antennas from the array of RF antennas.

Alternatively or in addition to any of the preceding examples, the method may further comprise: providing the determined orientation of one of the short-range wireless tags as an input to a computer program.

A third further example provides a sensing surface comprising: a sensing array; and a sensing module arranged to detect an orientation of a short-range wireless tag having a conductive footprint that is not rotationally symmetric.

The sensing array may comprise an array of RF antennas and the sensing module is arranged to: selectively activate an RF antenna from the array of RF antennas and to deactivate one or more other RF antennas from the array of RF antennas; read any proximate short-range wireless tags using the activated RF antenna; store a signal strength metric associated with each short-range wireless tag read by the activated RF antenna; repeat the selective activating and deactivating, reading and storing for a different activated RF antenna; and determine an orientation of one of the short-range wireless tags based at least in part on a plurality of signal strength metrics for the same short-range wireless tag when activated by different RF antennas from the array of RF antennas.

Alternatively or in addition to any of the preceding examples, the sensing array may comprise a capacitive sensing electrode array and the sensing module is arranged to: detect an area of increased capacitance using the capacitive sensing electrode array; and determine an orientation of a short-range wireless tag based on a shape of the area of increased capacitance.

Alternatively or in addition to any of the preceding examples, the sensing array may comprise a capacitive sensing electrode array and an array of RF antennas and the sensing module comprises a first module coupled to the capacitive sensing electrode array and a second module coupled to the array of RF antennas and wherein the sensing module is arranged to: detect, in the first module, changes in capacitance between electrodes in the capacitive sensing electrode array; in response to detecting, in the first module, an increase in capacitance between the electrodes at a first location, to identify, based on the first location, an RF antenna in the array of RF antennas, to detune, in the second module, one or more adjacent RF antennas in the array of RF antennas and to read, by the second module and via the identified RF antenna, data from any proximate wireless tags; and determine an orientation of a proximate short-range wireless tag based on the detected increase in capacitance and the data read from the proximate short-range wireless tag.

A fourth further example provides a method of detecting orientation of a short-range wireless tag using a sensing surface, the short-range wireless tag comprising an antenna that is not rotationally symmetric, the sensing surface comprising a capacitive sensing electrode array connected to a sensing module and the method comprising: detecting, in the sensing module, a plurality of capacitance measurements using the capacitive sensing electrode array; and determining an orientation of the short-range wireless tag based on the capacitance measurements.

A fifth further example provides a method of detecting orientation of a short-range wireless tag using a sensing surface, the short-range wireless tag comprising an antenna that is not rotationally symmetric, the sensing surface comprising an array of RF antennas and a capacitive sensing electrode array connected to a sensing module and the method comprising: grounding the array of RF antennas; detecting, in the sensing module, a plurality of capacitance measurements using the capacitive sensing electrode array; identifying, in the sensing module, one of the RF antennas based on the capacitance measurements; activating, in the sensing module, the identified RF antenna and deactivating, in the sensing module, one or more other RF antennas from the array of RF antennas; reading, at the sensing module, any proximate short-range wireless tags using the activated RF antenna; and determining an orientation of one of the short-range wireless tags based at least in part on the plurality of capacitance measurements and an ID of a proximate short-range wireless tag read by the sensing module using the array of RF antennas.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A short-range wireless tag having a conductive footprint that is not rotationally symmetric.

2. The short-range wireless tag according to claim 1, comprising an antenna that is not rotationally symmetric.

3. The short-range wireless tag according to claim 2, wherein the antenna comprises a first end and a second end wherein the first and second end have different coupling properties and the tag further comprises an IC connected to the antenna between the first and second ends.

4. The short-range wireless tag according to claim 3, wherein the antenna comprises a third end and wherein the IC is connected to the antenna between the first, second and third ends.

5. The short-range wireless tag according to claim 2, wherein the antenna comprises a first portion having a first length and a second portion having a second length, wherein the first and second portions are not arranged in line with each other and the first and second lengths are different.

6. The short-range wireless tag according to claim 2, wherein the antenna comprises a first portion having a first radius of curvature and a second portion having a second radius of curvature, wherein the first and second radii of curvature are different.

7. The short-range wireless tag according to claim 2, wherein the antenna comprises a coil which is not rotationally symmetric.

8. The short-range wireless tag according to claim 7, wherein the coil additionally lacks mirror symmetry.

9. The short-range wireless tag according to claim 1, comprising an antenna that is rotationally symmetric and one or more conductive regions that alone or in combination with the antenna provide the conductive footprint that is not rotationally symmetric.

10. The short-range wireless tag according to claim 9, wherein the conductive footprint additionally lacks mirror symmetry and the one or more conductive regions alone or in combination with the antenna provide the conductive footprint.

11. A method of detecting orientation of a short-range wireless tag using a sensing surface, the short-range wireless tag comprising an antenna that is not rotationally symmetric, the sensing surface comprising an array of RF antennas connected to a sensing module and the method comprising:
activating, in the sensing module, an RF antenna from the array of RF antennas and deactivating, in the sensing module, one or more other RF antennas from the array of RF antennas;
reading, at the sensing module, any proximate short-range wireless tags using the activated RF antenna;
storing, at the sensing module, a signal strength metric associated with each short-range wireless tag read by the activated RF antenna;
repeating the activating and deactivating, reading and storing for a different activated RF antenna; and
determining an orientation of one of the short-range wireless tags based at least in part on a plurality of signal strength metrics for the same short-range wireless tag when activated by different RF antennas from the array of RF antennas.

12. The method according to claim 11, wherein the signal strength metrics are generated in the sensing module based on measurements of signal strength made in the sensing surface.

13. The method according to claim 11, wherein the signal strength metrics are generated in the proximate short-range wireless tags based on measurements of voltages generated within the short-range wireless tags in response to activation of an RF antenna in the sensing surface.

14. The method according to claim 11, further comprising:
receiving, at the sensing surface from a proximate short-range wireless tag, signal strength metrics generated in the short-range wireless tag when activated by different RF antennas from the array of RF antennas.

15. The method according to claim 11, wherein the orientation of one of the short-range wireless tags is determined based on an identifier read from the short-range wireless tag and the plurality of signal strength metrics for the same short-range wireless tag when activated by different RF antennas from the array of RF antennas.

16. The method according to claim 11, further comprising:
providing the determined orientation of one of the short-range wireless tags as an input to a computer program.

17. A sensing surface comprising:
a sensing array; and
a sensing module arranged to detect an orientation of a short-range wireless tag having a conductive footprint which is not rotationally symmetric.

18. The sensing surface according to claim 17, wherein the sensing array comprises an array of RF antennas and the sensing module is arranged to:
selectively activate an RF antenna from the array of RF antennas and to deactivate one or more other RF antennas from the array of RF antennas;
read any proximate short-range wireless tags using the activated RF antenna;
store a signal strength metric associated with each short-range wireless tag read by the activated RF antenna;
repeat the selective activating and deactivating, reading and storing for a different activated RF antenna; and
determine an orientation of one of the short-range wireless tags based at least in part on a plurality of signal strength metrics for the same short-range wireless tag when activated by different RF antennas from the array of RF antennas.

19. The sensing surface according to claim 17, wherein the sensing array comprises a capacitive sensing electrode array and the sensing module is arranged to:
detect an area of increased capacitance using the capacitive sensing electrode array; and
determine an orientation of a short-range wireless tag based on a shape of the area of increased capacitance.

20. The sensing surface according to claim 17, wherein the sensing array comprises a capacitive sensing electrode array and an array of RF antennas and the sensing module comprises a first module coupled to the capacitive sensing electrode array and a second module coupled to the array of RF antennas and wherein the sensing module is arranged to:
detect, in the first module, changes in capacitance between electrodes in the capacitive sensing electrode array;
in response to detecting, in the first module, an increase in capacitance between the electrodes at a first location, to identify, based on the first location, an RF antenna in the array of RF antennas, to detune, in the second module, one or more adjacent RF antennas in the array of RF antennas and to read, by the second module and via the identified RF antenna, data from any proximate wireless tags; and
determine an orientation of a proximate short-range wireless tag based on the detected increase in capacitance and the data read from the proximate short-range wireless tag.
